(19) United States
(12) Patent Application Publication
(10) Pub. No.: US 2026/0220890 A1
(43) Pub. Date: Jul. 30, 2026

(54) INFORMATION PROCESSING SYSTEM, INFORMATION PROCESSING METHOD, AND INFORMATION PROCESSING PROGRAM

(71) Applicant: FUJIFILM Corporation, Tokyo (JP)

(72) Inventors: Koichi TANAKA, Saitama-shi (JP); Shinichi FUJIMOTO, Saitama-shi (JP); Kazuki ISHIDA, Saitama-shi (JP); Toshiki KOBAYASHI, Saitama-shi (JP)

(73) Assignee: FUJIFILM Corporation, Tokyo (JP)

(21) Appl. No.: 19/630,552

(22) Filed: Mar. 27, 2026

Related U.S. Application Data
(63) Continuation of application No. PCT/JP2024/032182, filed on Sep. 9, 2024.

(30) Foreign Application Priority Data
Sep. 28, 2023 (JP) 2023-168365

(51) Int. Cl. G06T 17/00

(52) U.S. Cl. CPC G06T 17/00

(57) ABSTRACT

Provided are an information processing system, an information processing method, and an information processing program that facilitate generation of a three-dimensional model of a physical object. An information processing system includes at least one processor. The processor is configured to: acquire first information including at least one of information on an object, information on an environment in which the object is imaged or measured, information on a condition under which the object is imaged or measured, or information on importance of imaging or measurement; and generate second information on generation of three-dimensional data of the object based on the first information.

### CROSS-REFERENCE TO RELATED APPLICATIONS

The present application is a Continuation of PCT International Application No. PCT/JP2024/032182 filed on Sep. 9, 2024 claiming priority under 35 U.S.C. § 119(a) to Japanese Patent Application No. 2023-168365 filed on Sep. 28, 2023. Each of the above applications is hereby expressly incorporated by reference, in its entirety, into the present application.

### BACKGROUND OF THE INVENTION

### 1. Field of the Invention

The present invention relates to an information processing system, an information processing method, and an information processing program, and particularly relates to an information processing system, an information processing method, and an information processing program that process information related to generation of a three-dimensional model.

### 2. Description of the Related Art

JP2003-168129A discloses a technology of generating a three-dimensional image of a physical object, and discloses that surface attribute data to be applied to a three-dimensional model is determined based on shape data acquired from the physical object.

JP2012-021958A discloses a technology of measuring a position and an orientation of a measurement object, and discloses that a measurement mode is switched based on a shape of model data that imitates the measurement object.

### SUMMARY OF THE INVENTION

One embodiment according to the technology disclosed herein provides an information processing system, an information processing method, and an information processing program that facilitate generation of a three-dimensional model of a physical object.

(1) An information processing system comprising: at least one processor configured to: acquire first information including at least one of information on an object, information on an environment in which the object is imaged or measured, information on a condition under which the object is imaged or measured, or information on importance of imaging or measurement; and generate second information on generation of three-dimensional data of the object based on the first information.
(2) The information processing system according to (1), in which the processor is configured to acquire the first information by receiving input of the first information from a user.
(3) The information processing system according to (1) or (2), in which the information on the object includes information on a transparent region, the information on the environment in which the object is imaged or measured includes information on an illumination status, and the information on the condition under which the object is imaged or measured includes at least one of information on whether the imaging or the measurement is performed in a handheld manner or information on a scanning speed.
(4) The information processing system according to any one of (1) to (3), in which the second information is information on a method used for the generation of the three-dimensional data, and the processor is configured to determine the method used for the generation of the three-dimensional data based on the first information.
(5) The information processing system according to (4), in which the first information includes at least information on a transparent region of the object, and the processor is configured to determine the method used for the generation of the three-dimensional data based on the information on the transparent region.
(6) The information processing system according to (5), in which the first information includes at least one of information on whether the transparent region is present or information on a proportion of the transparent region in the object, as the information on the transparent region, and the processor is configured to determine the method used for the generation of the three-dimensional data based on at least one of the information on whether the transparent region is present or the information on the proportion of the transparent region in the object.
(7) The information processing system according to (6), in which the processor is configured to determine whether to use photogrammetry or a visual hull method as the method used for the generation of the three-dimensional data.
(8) The information processing system according to any one of (5) to (7), in which the processor is configured to determine the method used for the generation of the three-dimensional data for each region of the object based on the information on the transparent region.
(9) The information processing system according to any one of (1) to (8), in which the second information is information on an imaging method of an image used for the generation of the three-dimensional data, the first information includes at least information on an illumination status, and the processor is configured to determine the imaging method of the image used for the generation of the three-dimensional data based on the information on the illumination status.
(10) The information processing system according to (9), in which the processor is configured to determine whether to adopt polarization imaging as the imaging method.
(11) The information processing system according to (9) or (10), in which the information on the illumination status includes at least one of information on whether specular reflection has occurred or information on a proportion of a region in which the specular reflection has occurred in the object.
(12) The information processing system according to any one of (9) to (11), in which the information on the illumination status includes information on whether an illumination causes specular reflection on the object.
(13) The information processing system according to any one of (9) to (12), in which the information on the illumination status includes information on whether an illumination is adjustable.
(14) The information processing system according to any one of (1) to (13), in which the first information includes at least information on whether the imaging is performed in a handheld manner, and the processor is configured to determine an imaging condition of the object based on the information on whether the imaging is performed in a handheld manner, and generate the second information.
(15) The information processing system according to (14), in which the processor is configured to determine, as the imaging condition, a setting of a shutter speed in a case of imaging the object.
(16) The information processing system according to any one of (1) to (15), in which the second information is information on an imaging condition of the object, the first information includes at least information on a scanning speed, and the processor is configured to determine the imaging condition based on the information on the scanning speed.
(17) The information processing system according to (16), in which the processor is configured to determine, as the imaging condition, a setting of a shutter speed in a case of imaging the object.
(18) The information processing system according to any one of (1) to (17), in which the second information is information on a processing condition in a case of generating the three-dimensional data, the first information includes at least the information on the importance of the imaging or the measurement, and the processor is configured to determine the processing condition based on the information on the importance of the imaging or the measurement.
(19) The information processing system according to (18), in which the processor is configured to determine, as the processing condition, a mode of processing of generating the three-dimensional data.
(20) An information processing method comprising: a step of acquiring first information including at least one of information on an object, information on an environment in which the object is imaged or measured, information on a condition under which the object is imaged or measured, or information on importance of imaging or measurement; and a step of generating second information on generation of three-dimensional data of the object based on the first information.
(21) An information processing program causing a computer to execute: a function of acquiring first information including at least one of information on an object, information on an environment in which the object is imaged or measured, information on a condition under which the object is imaged or measured, or information on importance of imaging or measurement; and a function of generating second information on generation of three-dimensional data of the object based on the first information.

### BRIEF DESCRIPTION OF THE DRAWINGS

FIG. 1 is a diagram illustrating a schematic configuration of a three-dimensional model generation system.

FIG. 2 is a block diagram illustrating an example of a hardware configuration of a three-dimensional model generation device.

FIG. 3 is a block diagram illustrating main functions of the three-dimensional model generation device.

FIG. 4 is a flowchart illustrating a procedure of processing of determining a generation method of a three-dimensional model.

FIG. 5 is a block diagram illustrating main functions of the three-dimensional model generation device.

FIG. 6 is a flowchart illustrating a procedure of processing of generating a three-dimensional model.

FIG. 7 is a diagram illustrating a schematic configuration of a three-dimensional model generation system.

FIG. 8 is a block diagram illustrating main functions of the three-dimensional model generation device.

FIG. 9 is a flowchart illustrating a procedure of processing of providing imaging support information.

FIG. 10 is a diagram illustrating a schematic configuration of a three-dimensional model generation system.

FIG. 11 is a block diagram illustrating main functions of the three-dimensional model generation device.

FIG. 12 is a flowchart illustrating a procedure of processing of providing imaging support information.

FIG. 13 is a diagram illustrating a schematic configuration of a three-dimensional model generation system.

FIG. 14 is a block diagram illustrating main functions of the three-dimensional model generation device.

FIG. 15 is a flowchart illustrating a procedure of processing of providing imaging support information.

FIG. 16 is a diagram illustrating a schematic configuration of a three-dimensional model generation system.

FIG. 17 is a block diagram illustrating main functions of the three-dimensional model generation device.

FIG. 18 is a flowchart illustrating a procedure of processing of generating a three-dimensional model from a multi-view image.

### DESCRIPTION OF THE PREFERRED EMBODIMENTS

Hereinafter, preferred embodiments of the present invention will be described in detail with reference to the accompanying drawings.

### First Embodiment

In recent years, three-dimensional content (content that can be viewed stereoscopically) has been actively used in fields such as games, metaverse-type communication spaces, architecture, and video production.

In a part of the production of three-dimensional content, a method (so-called three-dimensional scanning) of three-dimensionally scanning a physical object using a camera or dedicated device and converting a shape of the object into three-dimensional data is adopted.

Various methods such as photogrammetry, a visual hull method, a light detection and ranging (LiDAR) method, a time of flight (ToF) method, and a structured light method are used for the three-dimensional scanning. However, each method has advantages and disadvantages, making it difficult to select an optimal method.

In the present embodiment, a system (three-dimensional model generation system) is presented that can generate the high-quality three-dimensional model (shape model drawn in three dimensions) even for a user who is not knowledgeable about three-dimensional scanning.

### System Configuration

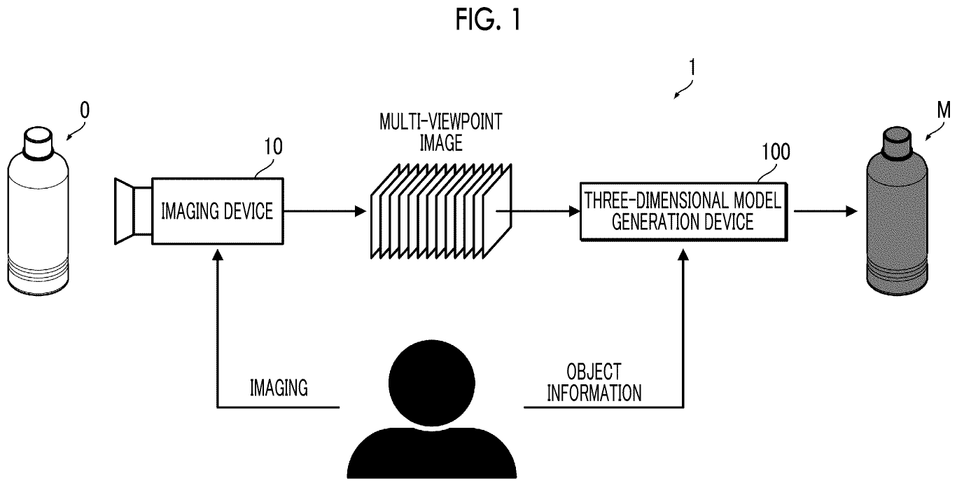

FIG. 1 is a diagram illustrating a schematic configuration of the three-dimensional model generation system.

The three-dimensional model generation system 1 according to the present embodiment is configured as a system that generates a three-dimensional model M of a physical object O. In particular, the three-dimensional model generation system 1 according to the present embodiment is configured as a system that images the object O from a plurality of viewpoints (multi-viewpoints) to generate the three-dimensional model M from a two-dimensional image group (multi-view image) obtained by the imaging.

The photogrammetry or the visual hull method is used for the generation of the three-dimensional model M. All of these are technologies (three-dimensional shape restoration technologies) of generating the three-dimensional model of the object from the multi-view image.

In the photogrammetry, a position and an orientation of a camera are estimated from an image by structure from motion (SfM), and a three-dimensional model is generated by multi-view stereo (MVS). As the image, an image captured by a general digital camera can be used.

The visual hull method, also called a silhouette method, is a technology of generating a three-dimensional model based on the silhouettes of an object. In the visual hull method, the silhouettes of an object captured from multi-viewpoints are used to construct cones (viewing volumes) whose vertices are the respective viewpoints and whose cross-sections are the silhouettes, the silhouettes are back-projected into three-dimensional space, and a three-dimensional model is generated by obtaining the intersection (common region) of these volumes. As in the photogrammetry, an image captured by a general digital camera can be used as the image, and the silhouette is extracted by a background difference and the like.

In the photogrammetry, feature point matching is performed between the images, and the three-dimensional model is generated using a processing result thereof. Therefore, an object for which a sufficient number of feature points cannot be obtained from the image, for example, a transparent or semi-transparent object is not suitable for the photogrammetry.

On the other hand, since the visual hull method is a method of generating the three-dimensional model using the silhouette, the three-dimensional model can be generated as long as the silhouette can be acquired even in a case in which the object has a transparent or semi-transparent portion. However, the accuracy of the three-dimensional shape that can be restored is lower than that of the photogrammetry.

The three-dimensional model generation system 1 according to the present embodiment acquires information on the object from the user, and automatically switches a generation method of the three-dimensional model based on the acquired information to generate the three-dimensional model of the object. The three-dimensional model is an example of three-dimensional data.

As illustrated in FIG. 1, the three-dimensional model generation system 1 according to the present embodiment comprises an imaging device 10 and a three-dimensional model generation device 100. The three-dimensional model generation system 1 of the present embodiment is an example of an information processing system.

### Imaging Device

The imaging device 10 is a device that images the object O. The imaging device 10 is configured by a general digital camera. That is, the imaging device 10 is configured by a camera that receives light transmitted through a lens with an imaging element (for example, a complementary metal-oxide-semiconductor (CMOS) image sensor), converts the light into a digital signal, and records the digital signal in a memory. The digital cameras also include those incorporated in other devices. For example, those incorporated in a smartphone, a tablet terminal, and the like are also included.

The imaging may be performed by one imaging device 10 or a plurality of imaging devices 10. Further, the imaging may be performed in a format of a moving image instead of a still image.

### Three-Dimensional Model Generation Device

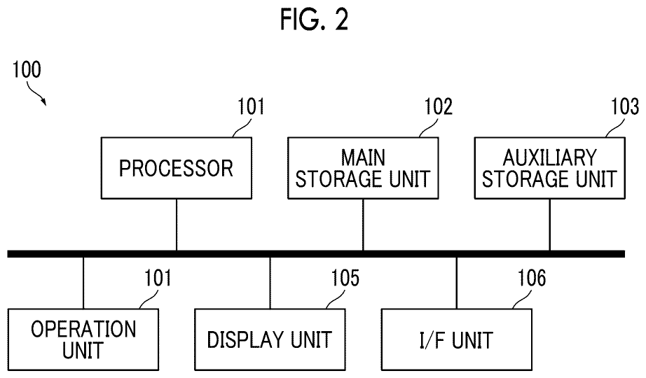

FIG. 2 is a block diagram illustrating an example of a hardware configuration of the three-dimensional model generation device.

The three-dimensional model generation device 100 is configured by a computer, such as a personal computer (PC), and comprises a processor 101, a main storage unit 102, an auxiliary storage unit 103, an operation unit 104, a display unit 105, an interface unit 106, and the like.

The processor 101 executes a program to function as various processing units. As an example, in the present embodiment, the processor 101 is configured by a central processing unit (CPU). Various programs or data executed by the processor 101 are stored in at least one of the main storage unit 102 or the auxiliary storage unit 103. The program is synonymous with software.

The main storage unit 102 includes a random-access memory (RAM) and a read-only memory (ROM). The RAM is used as a working area for the processor 101. The ROM stores a basic input/output program or the like.

The auxiliary storage unit 103 is configured, for example, by a hard disk drive (HDD) and a solid state drive (SSD).

The operation unit 104 is configured, for example, by a keyboard, a mouse, a touch panel, and the like.

The display unit 105 is configured, for example, by a liquid-crystal display (LCD), and an organic electro luminescence diode display (OLED display).

The interface unit 106 includes an interface for connecting to an external device such as the imaging device 10, an interface for connecting the three-dimensional model generation device 100 to a network, such as the Internet, and the like.

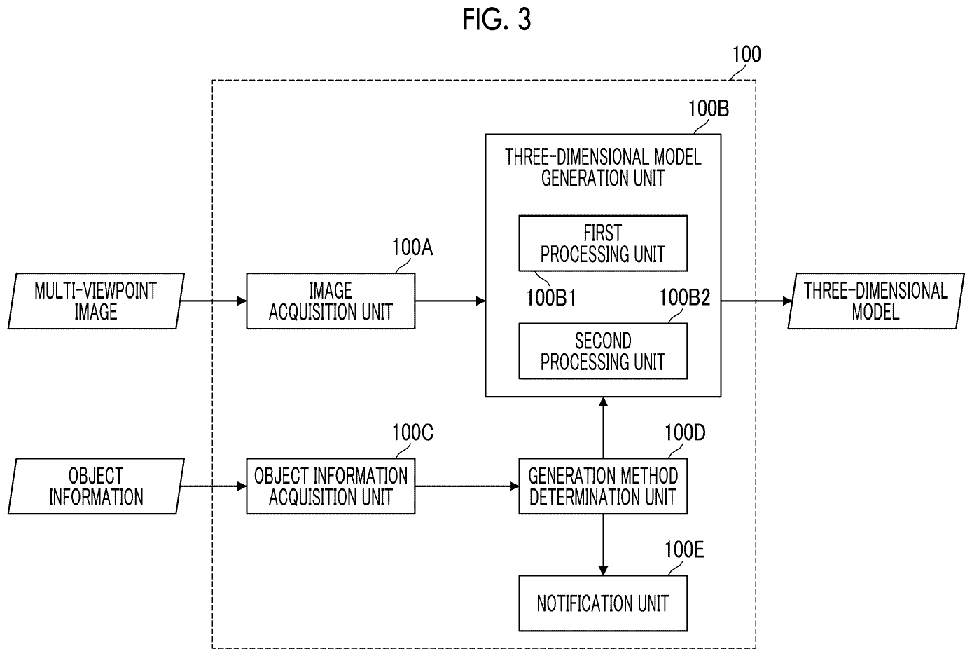

FIG. 3 is a block diagram illustrating the main functions of the three-dimensional model generation device.

As illustrated in FIG. 3, the three-dimensional model generation device 100 has functions of an image acquisition unit 100A, a three-dimensional model generation unit 100B, an object information acquisition unit 100C, a generation method determination unit 100D, a notification unit 100E, and the like. The functions of the respective units are achieved in a case in which the processor 101 executes a predetermined program.

The image acquisition unit 100A acquires the multi-view image of the object. The multi-view image is an image obtained by imaging the object from the multi-viewpoints. The multi-view image is captured by the imaging device 10, stored in the auxiliary storage unit 103, and read out and acquired from the auxiliary storage unit 103. Further, the multi-view image may be directly acquired from the imaging device 10.

The three-dimensional model generation unit 100B generates the three-dimensional model from the multi-view image. The three-dimensional model generation unit 100B includes a first processing unit 100B1 and a second processing unit 100B2. The first processing unit 100B1 generates the three-dimensional model by the photogrammetry. The second processing unit 100B2 generates the three-dimensional model by the visual hull method. Since the generation of the three-dimensional model by the photogrammetry and the visual hull method is a known technology, detailed description thereof will be omitted.

The three-dimensional model generation unit 100B generates the three-dimensional model using the generation method determined by the generation method determination unit 100D. Therefore, in a case in which the generation method determination unit 100D determines the generation of the three-dimensional model by the photogrammetry, the three-dimensional model generation unit 100B generates the three-dimensional model by the photogrammetry. Therefore, in this case, the three-dimensional model generation unit 100B processes the multi-view image by the first processing unit 100B1 and generates the three-dimensional model. On the other hand, in a case in which the generation method determination unit 100D determines the generation of the three-dimensional model by the visual hull method, the three-dimensional model generation unit 100B generates the three-dimensional model by the visual hull method. Therefore, in this case, the three-dimensional model generation unit 100B processes the multi-view image by the second processing unit 100B2 and generates the three-dimensional model.

The object information acquisition unit 100C acquires information on the object O (object information) for generating the three-dimensional model M. As an example, in the present embodiment, information on whether the object has a transparent region is acquired as the object information. The object information acquisition unit 100C displays a predetermined input screen on the display unit 105, receives an input of the information on whether the transparent region is present from the user, and acquires the information. For example, a screen for selecting “present” or “absent” for the transparent region is displayed on the display unit 105, and the user selects “present” or “absent”, and the information on whether the transparent region is present is acquired. The selection operation is performed through the operation unit 104. In the present embodiment, the information on whether the transparent region is present is an example of information on a transparent region of the object. Further, the object information is an example of first information.

The generation method determination unit 100D determines the generation method of the three-dimensional model based on the object information acquired by the object information acquisition unit 100C. More specifically, the generation method determination unit 100D determines whether to adopt the photogrammetry or the visual hull method as the generation method of the three-dimensional model. As described above, in the present embodiment, the information on whether the transparent region is present is acquired as the object information. Therefore, the generation method determination unit 100D determines the generation method of the three-dimensional model based on the information on whether the transparent region is present. Specifically, the generation method determination unit 100D determines the generation method of the three-dimensional model in accordance with the following criteria. That is, in a case in which the object has the transparent region, the generation method determination unit 100D determines the generation of the three-dimensional model by the visual hull method. On the other hand, in a case in which the transparent region is not present, the generation method determination unit 100D determines the generation of the three-dimensional model by the photogrammetry. In the present embodiment, the information on the generation method of the three-dimensional model determined by the generation method determination unit 100D is an example of second information.

The information on the generation method of the three-dimensional model determined by the generation method determination unit 100D is added to the three-dimensional model generation unit 100B. The three-dimensional model generation unit 100B generates the three-dimensional model from the multi-view image using the generation method determined by the generation method determination unit 100D.

The information on the generation method of the three-dimensional model determined by the generation method determination unit 100D is added to the notification unit 100E. The notification unit 100E notifies the user of the information on the determined generation method of the three-dimensional model. As an example, in the present embodiment, the information on the determined generation method of the three-dimensional model is displayed on the display unit 105 to notify the user.

### Generation of Three-Dimensional Model

Hereinafter, a method of generating the three-dimensional model M of the physical object O using the three-dimensional model generation system 1 according to the present embodiment will be described.

### (1) Determination of Generation Method of Three-Dimensional Model

First, the method of generating the three-dimensional model from the multi-view image is determined. That is, it is determined whether to adopt the photogrammetry or the visual hull method, and the three-dimensional model is generated.

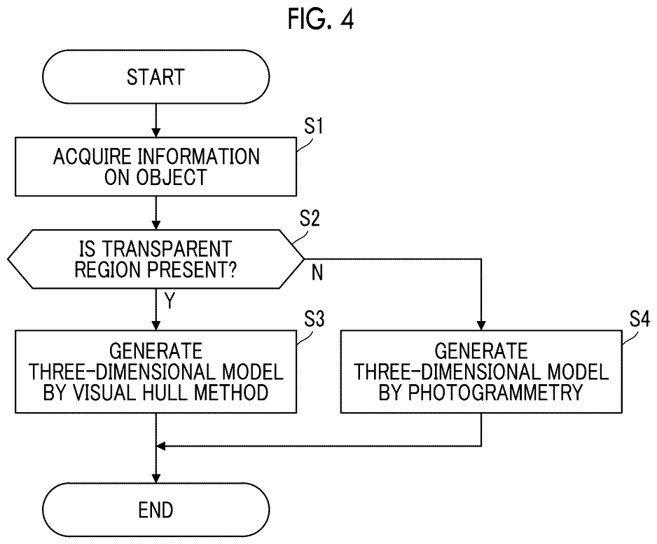

FIG. 4 is a flowchart illustrating a procedure of processing of determining the generation method of the three-dimensional model.

First, the object information is acquired from the user (step S1). In the present embodiment, the object information is information on whether the object has the transparent region. The three-dimensional model generation device 100 acquires the object information by receiving the input of the information on whether the transparent region is present from the user. The user checks whether the object for generating the three-dimensional model has the transparent region, and inputs the check result to the three-dimensional model generation device 100. That is, in a case in which the object has the transparent region, the information indicating that “transparent region is present” is input to the three-dimensional model generation device 100. On the other hand, in a case in which the object does not have the transparent region, the information indicating that “transparent region is absent” is input to the three-dimensional model generation device 100.

The three-dimensional model generation device 100 determines the generation method of the three-dimensional model based on the acquired object information (information on whether the transparent region is present). First, it is determined whether the transparent region is present (step S2). In a case in which the transparent region is present, the three-dimensional model generation device 100 determines the generation of the three-dimensional model by the visual hull method (step S3). On the other hand, in a case in which the transparent region is not present, the three-dimensional model generation device 100 determines the generation of the three-dimensional model by the photogrammetry (step S4).

As described above, the three-dimensional model generation device 100 determines the generation method of the three-dimensional model based on the object information (information on whether the transparent region is present) obtained by the user input.

The user is notified of the information on the determined generation method of the three-dimensional model. In the present embodiment, the information on the determined generation method of the three-dimensional model is displayed on the display unit 105. The user checks the display on the display unit 105, and checks the generation method of the three-dimensional model.

### (2) Generation of Three-dimensional Model

In the three-dimensional model generation system 1 of the present embodiment, the three-dimensional model is generated from the multi-view image.

First, the object O is imaged from the multi-viewpoints using the imaging device 10. As described above, the imaging may be performed using one imaging device 10 or may be performed using a plurality of imaging devices 10.

The captured multi-view image is input to the three-dimensional model generation device 100. The three-dimensional model generation device 100 generates the three-dimensional model by processing the input multi-view image. In such a case, the three-dimensional model is generated by the generation method determined in advance. That is, in a case in which it is determined to generate the three-dimensional model by the photogrammetry, the three-dimensional model is generated by the photogrammetry. On the other hand, in a case in which it is determined to generate the three-dimensional model by the visual hull method, the three-dimensional model is generated by the visual hull method.

As described above, with the three-dimensional model generation system 1 according to the present embodiment, the information on the object is acquired from the user, and the generation method of the three-dimensional model is automatically switched based on the acquired information to generate the three-dimensional model. Accordingly, even a user who is not knowledgeable about three-dimensional scanning can easily generate the high-quality three-dimensional model.

### Modification Example

### Transparent Region Information

In the above embodiment, the information on whether the transparent region is present is acquired as the information on the transparent region of the object, but instead of or in addition to this configuration, information on a proportion of the transparent region in the object may be acquired. The information on the proportion of the transparent region does not always need to be an accurate value, and an approximate value may be input. For example, a configuration may be adopted in which a numerical value that is visually estimated is input. In a case in which the information on the proportion of the transparent region is acquired as the information on the transparent region, a threshold value is set, and the generation method of the three-dimensional model is determined by comparing the threshold value. For example, in a case in which the proportion of the transparent region is equal to or less than the threshold value, the photogrammetry is selected, and in a case in which the proportion of the transparent region exceeds the threshold value, the visual hull method is selected.

In addition, for example, a configuration may be adopted in which the user subjectively determines an amount of transparent region and acquires the determination result as the information on the transparent region. In this case, the generation method of the three-dimensional model is determined based on the information indicating that the proportion of the transparent region is large or small. Specifically, in a case in which the information indicating that the proportion of the transparent region is small is input, the photogrammetry is selected, and in a case in which the information indicating that the proportion of the transparent region is large is input, the visual hull method is selected.

### Object Information

In the above embodiment, the information on the transparent region (particularly, the information on whether the transparent region is present) is acquired as the information on the object (object information), but the information acquired as the information on the object is not limited to this. Instead of or in addition to the information on the transparent region, other information may be acquired.

For example, in a case of generating the three-dimensional model by the photogrammetry or the visual hull method, information on a texture of the object, information on glossiness, and the like can be acquired to determine the method to be used. In a case of acquiring the information on the texture of the object to determine the method to be used, for example, the method to be used is determined based on the presence or absence of the texture or the degree of the texture. Specifically, in a case in which the texture is not present or is weak, the visual hull method is selected, and in other cases, the photogrammetry is selected. In addition, in a case of acquiring the information on the glossiness to determine the method to be used, the method to be used is determined based on the presence or absence of the glossiness or the degree of the glossiness. Specifically, in a case in which the glossiness is present or is strong, the visual hull method is selected, and in other cases, the photogrammetry is selected.

### Acquisition Method of Object Information

In the above embodiment, the user manually inputs the information on the object (object information), but the information may be automatically acquired. For example, in a case of acquiring the information on whether the transparent region is present as the object information, a configuration may be adopted in which the presence or absence of the transparent region is determined from an image obtained by imaging the object. An image obtained by imaging the object can be used as the multi-view image (the presence or absence of the transparent region is determined by using at least one of a plurality of images constituting the multi-view image). Further, a known image recognition method may be adopted for the detection of the transparent region. For example, the transparent region can be detected from the image using a trained machine learning model that has been trained by machine learning to recognize the transparent region from the image.

In addition, a configuration may be adopted in which, as the object information, an input of a name (product name) of the object is received from the user, the information on whether the transparent region is present is acquired. In this case, for example, a table in which the name of the object and the information on whether the transparent region is present are associated with each other is prepared, and the information on whether the transparent region is present is acquired from the name of the object by referring to the table.

### Generation Method of Three-Dimensional Model

In the above embodiment, a case of generating the three-dimensional model of the object from the multi-view image by the photogrammetry or the visual hull method is described as an example, but the method of generating the three-dimensional model of the object is not limited to this. Further, a plurality of methods may be selected. Furthermore, other three-dimensional scanning methods may be selected. For example, a configuration may be adopted in which the three-dimensional model can be generated by using a LiDAR method, a ToF method, a structured light method, or the like.

### Manual Selection

In the above embodiment, the method to be used for generating the three-dimensional model is automatically selected in accordance with the determination, but the method may be manually selected. In the above embodiment, the user is notified of the information on the generation method of the three-dimensional model determined by the generation method determination unit 100D via the notification unit 100E. The user determines the generation method of the three-dimensional model by referring to the notified information. In such a case, the three-dimensional model generation device 100 functions as a device that supports the generation of the three-dimensional model.

### Second Embodiment

In the present embodiment, in a case in which the object has the transparent region, the three-dimensional model of the object is generated by changing the generation method of the three-dimensional model for each region. Here, a case of generating the three-dimensional model of the object from the multi-view image will be described as an example. In particular, a case of generating the three-dimensional model by using the photogrammetry and the visual hull method will be described as an example.

As described above, the photogrammetry is not suitable for a transparent or semi-transparent object. On the other hand, the visual hull method can generate the three-dimensional model as long as the silhouette can be acquired even in a case in which the object has a transparent or semi-transparent portion.

In the present embodiment, in a case in which the object has the transparent region (including the semi-transparent region), the transparent region is converted into three-dimensional data by the visual hull method, and a non-transparent region is converted into three-dimensional data by the photogrammetry.

A hardware configuration of the device (three-dimensional model generation device) used for generating the three-dimensional model is the same as that of the three-dimensional model generation device 100 according to the first embodiment. Therefore, here, only the function of the three-dimensional model generation device 100 will be described.

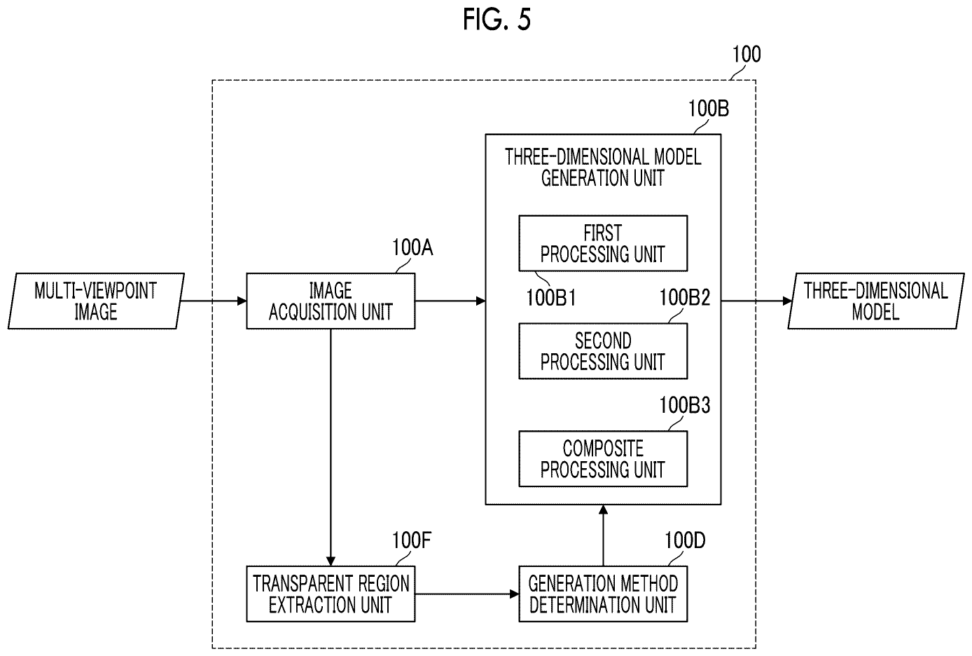

FIG. 5 is a block diagram illustrating the main functions of the three-dimensional model generation device.

As illustrated in FIG. 5, the three-dimensional model generation device 100 has functions of an image acquisition unit 100A, a three-dimensional model generation unit 100B, a transparent region extraction unit 100F, a generation method determination unit 100D, and the like. The functions of the respective units are achieved in a case in which the processor 101 executes a predetermined program.

The image acquisition unit 100A acquires the multi-view image of the object.

The three-dimensional model generation unit 100B generates the three-dimensional model from the multi-view image. The three-dimensional model generation unit 100B has functions of a first processing unit 100B1, a second processing unit 100B2, a composite processing unit 100B3, and the like. The first processing unit 100B1 generates the three-dimensional model from the multi-view image by the photogrammetry. The second processing unit 100B2 generates the three-dimensional model from the multi-view image by the visual hull method. The composite processing unit 100B3 combines the three-dimensional models generated for each region to generate one three-dimensional model that constitutes the entire three-dimensional model.

The three-dimensional model generation unit 100B generates the three-dimensional model for each region of the object in accordance with the generation method (three-dimensional shape restoration method) for each region determined by the generation method determination unit 100D.

The transparent region extraction unit 100F extracts the transparent region (including the semi-transparent region) of the object, and specifies a position and a range thereof. The transparent region extraction unit 100F extracts the transparent region of the object from the multi-view image, and specifies a position and a range thereof. A known image recognition method may be adopted for the extraction of the transparent region. The information (position and range) on the transparent region is added to the generation method determination unit 100D.

The generation method determination unit 100D determines the generation method of the three-dimensional model, for each region. Specifically, the visual hull method is selected for the transparent region, and the photogrammetry is selected for the non-transparent region. In a case in which the entire object is transparent, it is determined to generate the entire object by the visual hull method. In addition, in a case in which the entire object is non-transparent, it is determined to generate the entire object by the photogrammetry.

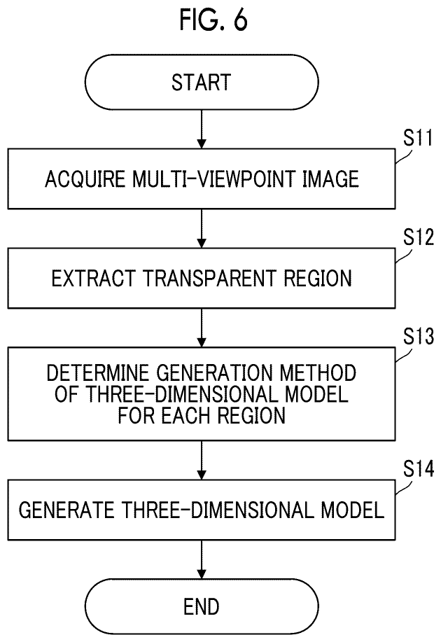

FIG. 6 is a flowchart illustrating a procedure of processing of generating the three-dimensional model.

First, the multi-view image of the object is acquired (step S11). The multi-view image is captured by the imaging device 10, stored in the auxiliary storage unit 103, and read out and acquired from the auxiliary storage unit 103. The multi-view image may be captured using one imaging device 10 or may be captured using a plurality of imaging devices 10.

Next, the transparent region of the object is extracted from the acquired multi-view image, and the position and the range thereof are specified (step S12).

Next, the generation method of the three-dimensional model is determined for each region based on the information on the transparent region of the object (step S13). Specifically, the visual hull method is selected for the transparent region, and the photogrammetry is selected for the non-transparent region.

Next, the three-dimensional model of the object is generated from the multi-view image by using the determined generation method (step S14). Here, in a case in which the entire object is transparent, the three-dimensional model of the entire object is generated by the visual hull method. In addition, in a case in which the entire object is non-transparent, the three-dimensional model of the entire object is generated by the photogrammetry. In addition, in a case in which the object includes the transparent region in a part thereof, the three-dimensional model of the transparent region is generated by the visual hull method, and the three-dimensional model of the non-transparent region is generated by the photogrammetry. Then, the data of each region is combined to generate one three-dimensional model as a whole.

As described above, according to the present embodiment, the high-quality three-dimensional model can be easily generated by changing the generation method of the three-dimensional model for each region.

In the above embodiment, a case of automatically generating the three-dimensional model is described as an example, but a configuration may be adopted in which the three-dimensional model suitable for each region is presented to the user.

In addition, in the above embodiment, a case of generating the three-dimensional model from the two-dimensional image is described as an example, but the method of three-dimensional scanning to be used is not limited to this. A configuration may also be adopted in which other methods are used.

### Third Embodiment

In a case of generating the three-dimensional model from the image obtained by imaging the object, in a case in which the specular reflection (gloss) has occurred in the object shown in the image, there is a problem that a raw state (a state in which the influence of light is excluded) of the object cannot be reproduced.

As the method of suppressing the specular reflection, there is a method of performing the imaging using a polarization filter. However, the workability is worse than the normal imaging, such as performing the imaging by setting the polarization filter at an appropriate angle.

In the present embodiment, a system is presented that can capture a high-quality image suitable for generating the three-dimensional model even for a user who is not knowledgeable about the imaging.

### Three-Dimensional Model Generation System

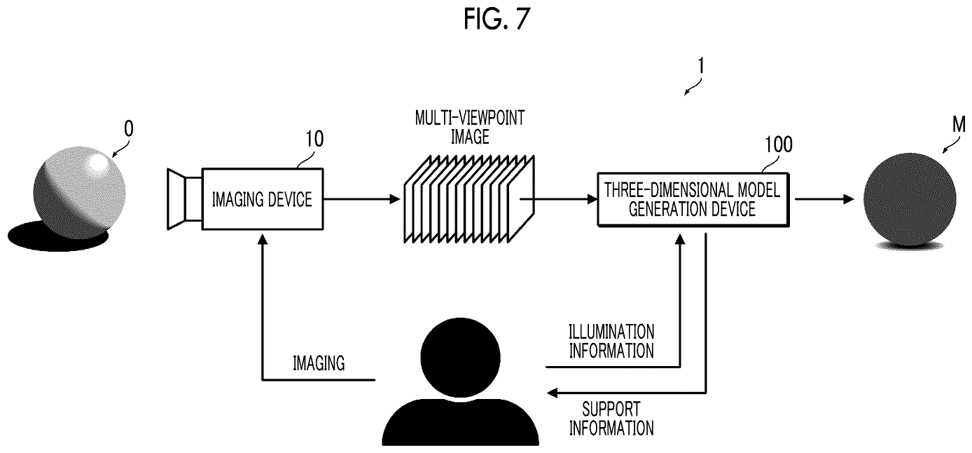

FIG. 7 is a diagram illustrating a schematic configuration of the three-dimensional model generation system.

The three-dimensional model generation system 1 according to the present embodiment is configured as a system that generates the three-dimensional model M of the object O from the multi-view image.

As illustrated in FIG. 7, the three-dimensional model generation system 1 comprises an imaging device 10 and a three-dimensional model generation device 100.

### Imaging Device

The imaging device 10 is a device that images the object O. The imaging device 10 is configured by a general digital camera. The imaging may be performed by one imaging device 10 or a plurality of imaging devices 10.

### Three-dimensional Model Generation Device

A hardware configuration of the three-dimensional model generation device 100 is the same as that of the three-dimensional model generation device 100 according to the first embodiment. That is, the three-dimensional model generation device 100 is configured by a computer, such as a PC, and comprises a processor 101, a main storage unit 102, an auxiliary storage unit 103, an operation unit 104, a display unit 105, an interface unit 106, and the like (see FIG. 2).

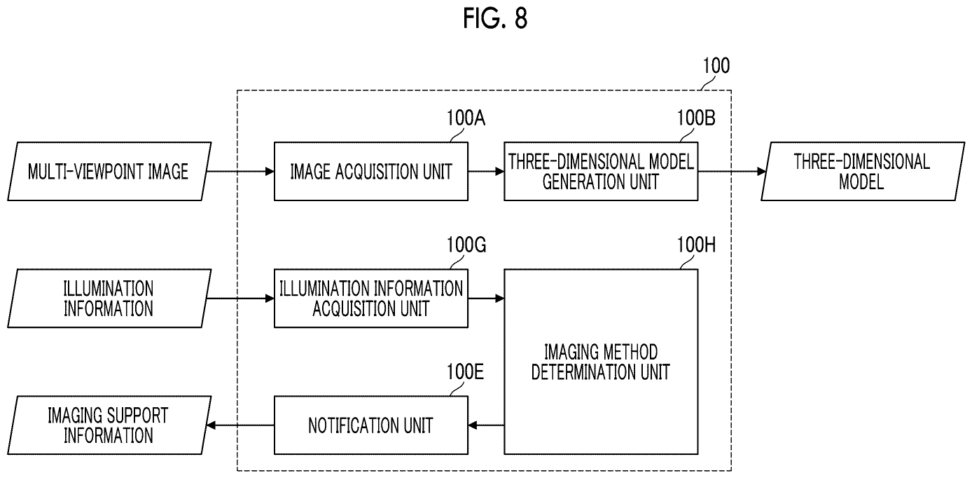

FIG. 8 is a block diagram illustrating the main functions of the three-dimensional model generation device.

The three-dimensional model generation device 100 has a function (three-dimensional model generation function) of generating the three-dimensional model of the object from the multi-view image and a function (imaging support function) of supporting the imaging of the multi-view image.

### Three-Dimensional Model Generation Function

The three-dimensional model generation function is a function of generating the three-dimensional model of the object from the multi-view image. The three-dimensional model generation device 100 has functions of an image acquisition unit 100A, a three-dimensional model generation unit 100B, and the like, as the three-dimensional model generation function.

The image acquisition unit 100A acquires the multi-view image of the object. The multi-view image is captured by the imaging device 10, stored in the auxiliary storage unit 103, and read out and acquired from the auxiliary storage unit 103. Further, the multi-view image may be directly acquired from the imaging device 10.

The three-dimensional model generation unit 100B generates the three-dimensional model from the multi-view image. As an example, in the present embodiment, the three-dimensional model of the object is generated from the multi-view image by the photogrammetry.

### Imaging Support Function

In the present embodiment, a function of presenting information (imaging support information) for supporting the imaging of the multi-view image to the user is provided as the imaging support function. Specifically, an optimal imaging method (recommended imaging method) is determined from an environment in which the object is imaged, particularly an illumination status, and is presented to the user. As illustrated in FIG. 7, the three-dimensional model generation device 100 has functions of an illumination information acquisition unit 100G, an imaging method determination unit 100H, a notification unit 100E, and the like, as the imaging support function.

The illumination information acquisition unit 100G acquires information (illumination information) on the illumination status. The illumination information acquisition unit 100G acquires the information on the illumination status by receiving the input of the information on the illumination status from the user. In the present embodiment, information on whether the specular reflection has occurred is acquired as the illumination information. That is, the information on whether the illumination status in which the specular reflection has occurred is acquired as the illumination information. The illumination information acquisition unit 100G displays a predetermined input screen on the display unit 105, and receives the input of the information on whether the specular reflection has occurred from the user. For example, a screen for selecting “occurred” or “not occurred” for the specular reflection is displayed on the display unit 105, and the user is allowed to select “occurred” or “not occurred”, and the information on whether the specular reflection has occurred is acquired. The selection operation is performed through the operation unit 104. In the present embodiment, the information on whether the specular reflection has occurred is an example of the information on the illumination status. In addition, the information on the illumination status is an example of the information on the environment in which the object is imaged (or measured), and is an example of the first information.

The imaging method determination unit 100H determines an optimal imaging method (recommended imaging method) based on the information on the illumination status (in the present embodiment, the information on whether the specular reflection has occurred) acquired from the user. Here, the imaging using the polarization filter is referred to as “polarization imaging”, the imaging not using the polarization filter is referred to as “normal imaging”, and it is determined which of the imaging methods should be adopted (whether to perform the polarization imaging is determined). Specifically, in a case in which “specular reflection has occurred”, the “polarization imaging” is selected. On the other hand, in a case in which “specular reflection has not occurred”, the “normal imaging” is selected. In this embodiment, the information on the imaging method determined by the imaging method determination unit 100H (information on the imaging method of the image used for the generation of the three-dimensional data) is an example of the second information.

The notification unit 100E notifies the user of the information on the imaging method determined by the imaging method determination unit 100H, as the imaging support information. For example, in the present embodiment, the information on the determined imaging method (imaging support information) is displayed on the display unit 105 to notify the user.

### Generation of Three-Dimensional Model

Hereinafter, a method of generating the three-dimensional model M of the object O from the multi-view image using the three-dimensional model generation system 1 according to the present embodiment will be described.

### (1) Provision of Imaging Support Information

First, the three-dimensional model generation device 100 provides the imaging support information.

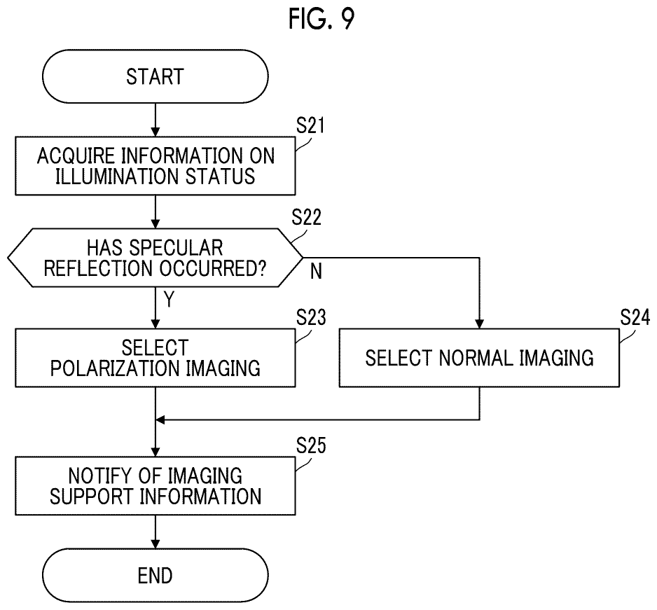

FIG. 9 is a flowchart illustrating a procedure of processing of providing the imaging support information in the three-dimensional model generation device.

First, the information on the illumination status is acquired from the user (step S21). In the present embodiment, the information on the illumination status is acquired by receiving the input of the information on the illumination status from the user. The information on the illumination status is the information on whether the specular reflection has occurred.

The three-dimensional model generation device 100 determines the imaging method based on the acquired information on the illumination status (information on whether the specular reflection has occurred). First, it is determined whether the specular reflection has occurred (step S22). In a case in which “specular reflection has occurred”, the three-dimensional model generation device 100 selects “polarization imaging” as the imaging method (step S23). On the other hand, in a case in which “specular reflection has not occurred”, the three-dimensional model generation device 100 selects “normal imaging” as the imaging method (step S24).

The three-dimensional model generation device 100 notifies the user of the information on the determined imaging method, as the imaging support information (step S25). In this embodiment, the information on the determined imaging method (imaging support information) is displayed on the display unit 105 to notify the user. The imaging support information is provided to the user as information on the optimal imaging method based on the illumination status.

### (2) Generation of Three-Dimensional Model

The user determines the imaging method in response to the presentation of the imaging support information, and images the object to obtain the multi-view image. For example, in a case in which the normal imaging is presented as the optimal imaging method, the object is imaged by the normal imaging method (imaging method not using the polarization filter). On the other hand, in a case in which the polarization imaging is presented as the optimal imaging method, the object is imaged by using the polarization filter. Specifically, the polarization filter is mounted on the lens, is set at an appropriate angle (angle at which the specular reflection can be suppressed), and the object is imaged.

The captured multi-view image is input to the three-dimensional model generation device 100. The three-dimensional model generation device 100 generates the three-dimensional model by processing the input multi-view image.

As described above, according to the present embodiment, the object can be imaged by suppressing the occurrence of the specular reflection. As a result, the high-quality three-dimensional model can be generated. In addition, an appropriate imaging method can be selected in accordance with the illumination status, and the balance between the quality of the generated three-dimensional model and the work efficiency can be optimized.

### Modification Example

### Illumination Status Information

In the above embodiment, the information on whether the specular reflection has occurred is acquired as the information on the illumination status, but instead of or in addition to this, information on a proportion of a region in which the specular reflection has occurred in the object may be acquired. The proportion does not always need to be an accurate value, and an approximate value may be input. For example, a configuration may be adopted in which a numerical value that is visually estimated is input. In a case in which this information is acquired as the information on the illumination status, a threshold value is set, and the imaging method is determined by comparing the threshold value. For example, in a case in which the proportion of the region in which the specular reflection has occurred in the object is equal to or less than the threshold value, the normal imaging is selected, and in a case in which the proportion exceeds the threshold value, the polarization imaging is selected.

Further, the information on the degree (strength) of the specular reflection may be acquired as the information on the illumination status. The information on the degree of the specular reflection may be input by the user by visually checking the information. In such a case, for example, in a case of strong specular reflection, the polarization imaging is selected, and in a case of weak specular reflection, the normal imaging is selected.

In addition, for example, a configuration may be adopted in which the user subjectively determines the amount of the region in which the specular reflection has occurred, and acquires the determination result as the information on the illumination status. In this case, the imaging method is determined based on the information indicating that the proportion of the region in which the specular reflection has occurred is large or small. Specifically, in a case in which the information indicating that the proportion is small is input, the normal imaging is selected, and in a case in which the information indicating that the proportion is large is input, the polarization imaging is selected.

In addition, the information on the setting status of the illumination device may be acquired as the information on the illumination status. For example, information such as the number of illumination devices, the presence or absence of the use of the diffuser, and the setting of brightness may be acquired as the information on the illumination status. By acquiring these pieces of information, it is possible to estimate whether the specular reflection has occurred. As a result, the optimal imaging method (recommended imaging method) can be estimated. For example, by uniformly illuminating the object with illumination light using a plurality of illumination devices, the occurrence of the specular reflection can be suppressed. Therefore, the optimal imaging method can be selected in accordance with the number of illumination devices. For example, in a case in which a plurality (equal to or more than the threshold value) of illumination devices are used, the normal imaging is selected by assuming that the illumination status in which the occurrence of the specular reflection is suppressed. Further, the occurrence of the specular reflection can be suppressed by the diffuser. Therefore, the optimal imaging method can be selected in accordance with the presence or absence of the use of the diffuser. Further, the occurrence of the specular reflection can be suppressed by the setting of the brightness. As a result, the optimal imaging method can be selected by the setting of the brightness.

Furthermore, as the information on the imaging environment, information on an illumination environment, for example, information (information on adjustability of the illumination) on whether the illumination can be adjusted may be acquired, and the optimal imaging method (recommended imaging method) may be determined based on the acquired information. For example, in the environment (for example, outdoors) in which the illumination cannot be adjusted, the polarization imaging is suitable. Therefore, information on whether the environment is an environment in which the illumination can be adjusted is acquired, and the imaging method is determined based on the information. Specifically, in a case of the environment in which the illumination can be adjusted, the normal imaging is selected, and in a case of the environment in which the illumination cannot be adjusted, the polarization imaging is selected.

In addition, as the information on the illumination environment, information on whether the illumination causes the specular reflection in the object may be acquired, and the optimal imaging method (recommended imaging method) may be determined based on the acquired information. For example, in a case of the illumination that causes the specular reflection in the object, the polarization imaging is selected, and in other cases, the normal imaging is selected.

As described above, the information on the illumination status or the information on the environment in which the object is imaged need only be information from which the presence or absence or the degree of the occurrence of the specular reflection can be determined.

### Acquisition Method of Illumination Status Information

In the above embodiment, the user manually inputs the information on the illumination status, but the information may be automatically acquired. For example, a configuration may be adopted in which the presence or absence and/or the degree of the occurrence of the specular reflection is determined from the image obtained by imaging the object, and the information on the illumination status is automatically acquired. An image obtained by imaging the object can be used as the multi-view image (the presence or absence of the occurrence of the specular reflection is determined by using at least one of a plurality of images constituting the multi-view image).

### Generation Method of Three-Dimensional Model

In the above embodiment, a case of generating the three-dimensional model of the object from the multi-view image by the photogrammetry is described as an example, but the same applies to a case of generating the three-dimensional model by using other methods (for example, the visual hull method).

It can be applied to a case of generating the three-dimensional model by other three-dimensional scanning methods. For example, in a case of generating the three-dimensional model by the LiDAR method, a configuration may be adopted in which information on the environment in which the object is measured is acquired, the optimal measurement method is determined based on the acquired information, and the optimal measurement method is presented to the user.

### Presentation of Imaging Support Information

In the above embodiment, the imaging support information (information on the optimal imaging method) is displayed on the display unit 105 of the three-dimensional model generation device 100 to notify the user, but the method of notifying the user of the imaging support information is not limited to this. For example, a configuration in which the imaging support information is transmitted to the imaging device 10 and is displayed on the display unit of the imaging device 10 may be adopted.

In addition, in the above embodiment, a case in which the three-dimensional model generation device 100 comprises the imaging support function is described as an example, but the imaging support function may be provided independently and installed in another device. For example, the imaging support function may be installed in the imaging device 10. Alternatively, the imaging support function may be installed in a portable device such as a smartphone or a tablet terminal.

### Imaging Support

In a case of performing the polarization imaging, the information on the setting of the polarization filter may also be provided to the user. For example, in a case of fixing the imaging device 10 and rotating the object side to perform the imaging, an optimal setting angle of the polarization filter may be calculated and provided to the user.

### Fourth Embodiment

In a case of generating the three-dimensional model of the object from the image obtained by imaging the object, the object needs to be imaged from the multi-viewpoints.

As an imaging form of the multi-view image, there are a form in which the object side is moved to perform the imaging and a form in which the imaging device side is moved to perform the imaging.

In the form in which the object side is moved to perform the imaging, imaging using a turntable is common. In the imaging using the turntable, the object is placed on the turntable and rotated, and is imaged from a fixed position by the imaging device.

On the other hand, in the form in which the imaging device side is moved to perform the imaging, imaging in a handheld manner is common. In the imaging in a handheld manner, a person who captures an image (user) holds the imaging device with a hand and images the object from various directions.

The imaging in a handheld manner has an advantage that the imaging can be easily and easily performed, but has a disadvantage that image blur is likely to occur due to camera shake. The image in which the image blur has occurred adversely affects the generation of the three-dimensional model.

On the other hand, the influence of the camera shake can be suppressed by changing the imaging condition, for example, by increasing the shutter speed.

In the present embodiment, a system is presented that can capture a high-quality image suitable for generating the three-dimensional model even for a user who is not knowledgeable about the imaging.

### Three-Dimensional Model Generation System

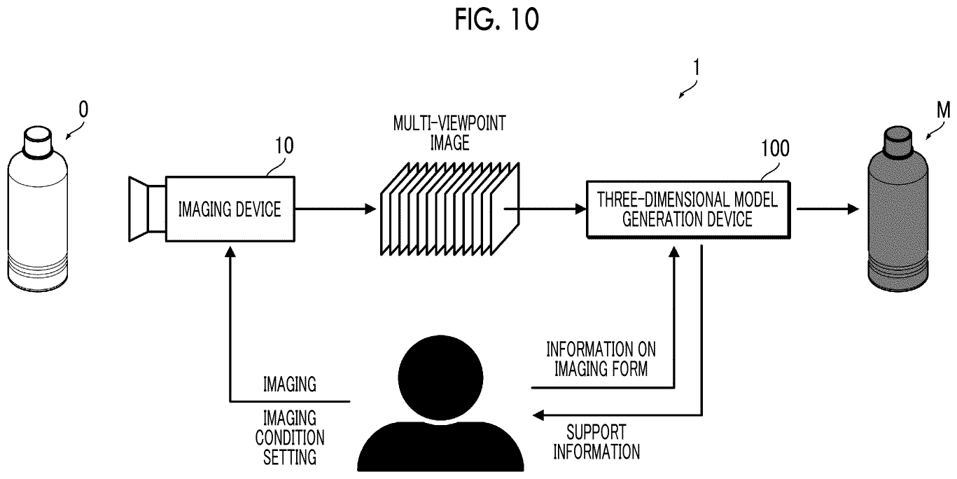

FIG. 10 is a diagram illustrating a schematic configuration of the three-dimensional model generation system.

The three-dimensional model generation system 1 according to the present embodiment is configured as a system that generates the three-dimensional model M of the object O from the multi-view image.

As illustrated in FIG. 10, the three-dimensional model generation system 1 comprises an imaging device 10 and a three-dimensional model generation device 100.

### Imaging Device

The imaging device 10 is a device that images the object O. The imaging device 10 is configured by a general digital camera.

### Three-Dimensional Model Generation Device

A hardware configuration of the three-dimensional model generation device 100 is the same as that of the three-dimensional model generation device 100 according to the first embodiment. That is, the three-dimensional model generation device 100 is configured by a computer, such as a PC, and comprises a processor 101, a main storage unit 102, an auxiliary storage unit 103, an operation unit 104, a display unit 105, an interface unit 106, and the like (see FIG. 2).

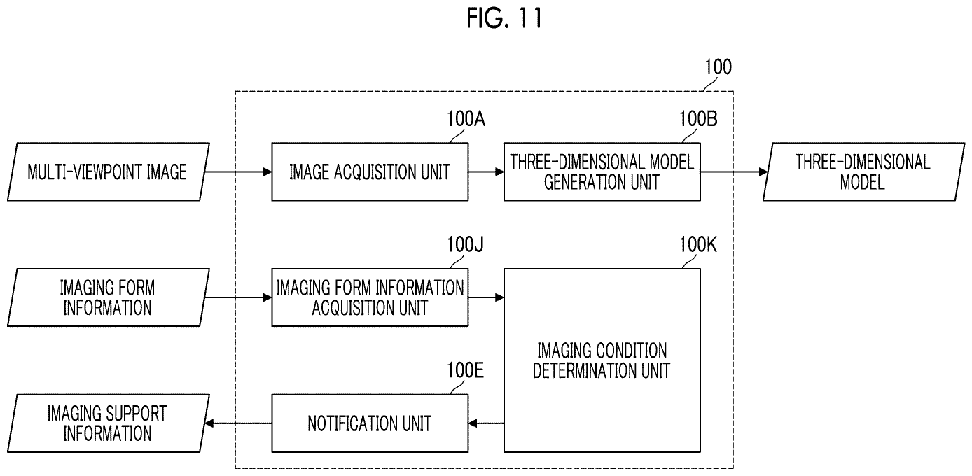

FIG. 11 is a block diagram illustrating the main functions of the three-dimensional model generation device.

The three-dimensional model generation device 100 has a function (three-dimensional model generation function) of generating the three-dimensional model of the object from the multi-view image and a function (imaging support function) of supporting the imaging of the multi-view image.

### Three-Dimensional Model Generation Function

The three-dimensional model generation function is the same as the three-dimensional model generation function in the three-dimensional model generation device 100 according to the third embodiment. Therefore, the description will not be repeated.

### Imaging Support Function

In the present embodiment, as the imaging support function, the information on the imaging form is acquired from the user, the imaging condition is determined based on the acquired information, and the imaging condition is presented to the user. As illustrated in FIG. 11, the three-dimensional model generation device 100 has functions of an imaging form information acquisition unit 100J, an imaging condition determination unit 100K, a notification unit 100E, and the like, as the imaging support function.

The imaging form information acquisition unit 100J acquires the information on the imaging form (imaging form information). The imaging form information acquisition unit 100J acquires the information on the imaging form by receiving the input of the information on the imaging form by the user. In the present embodiment, the information on whether the imaging is performed in a handheld manner is acquired as the imaging form information. The imaging form information acquisition unit 100J displays a predetermined input screen on the display unit 105, and receives the input of the information on whether the imaging is performed in a handheld manner from the user. For example, a screen for selecting “yes” or “no” for whether the imaging is performed in a handheld manner is displayed on the display unit 105, and the user selects “yes” or “no”, and the information on whether the imaging is performed in a handheld manner is acquired. The selection operation is performed through the operation unit 104. In the present embodiment, the information on the imaging form (information on whether the imaging is performed in a handheld manner) acquired by the imaging form information acquisition unit 100J is an example of the first information.

The imaging condition determination unit 100K determines the imaging condition based on the information on the imaging form acquired from the user. In the present embodiment, in a case of the imaging in a handheld manner, it is determined to perform the imaging at a high shutter speed as the imaging condition. The phrase “imaging at high shutter speed” means that the imaging is performed by setting a high (fast) shutter speed. On the other hand, in a case of not performing the imaging in a handheld manner, it is determined to perform the imaging at a low shutter speed as the imaging condition. The phrase “imaging at low shutter speed” means that the imaging is performed by setting a low (slow) shutter speed.

The “high shutter speed” and the “low shutter speed” are determined from the viewpoint of suppressing the influence of the camera shake. That is, in a case of the imaging in a handheld manner, the shutter speed at which the influence of the camera shake can be suppressed is the “high shutter speed”. In general, it is considered that the influence of the camera shake can be suppressed by setting the shutter speed to be faster than 1/focal length [seconds]. Therefore, the phrase “imaging at high shutter speed” means that the imaging is performed by setting the shutter speed to be faster than 1/focal length [seconds]. On the other hand, the phrase “imaging at low shutter speed” means that the imaging is performed by setting the shutter speed to be slower than 1/focal length [seconds]. In addition, with 1/60 [seconds] as a reference, the shutter speed faster than 1/60 [seconds] can be defined as the “high shutter speed”, and the shutter speed slower than 1/60 [seconds] can be defined as the “low shutter speed”. The shutter speed at which the influence of the camera shake can be suppressed varies depending on whether the camera shake correction function is provided. Therefore, it is preferable to set the shutter speed as a reference for high and low based on whether the camera shake correction function is provided.

In this embodiment, the information on the imaging condition determined by the imaging condition determination unit 100K is an example of the second information.

The notification unit 100E notifies the user of the information on the imaging condition determined by the imaging condition determination unit 100K, as the imaging support information. For example, in the present embodiment, the information on the determined imaging condition (imaging support information) is displayed on the display unit 105 to notify the user.

### Generation of Three-Dimensional Model

Hereinafter, a method of generating the three-dimensional model M of the object O from the multi-view image using the three-dimensional model generation system 1 according to the present embodiment will be described.

### (1) Provision of Imaging Support Information

First, the three-dimensional model generation device 100 provides the imaging support information.

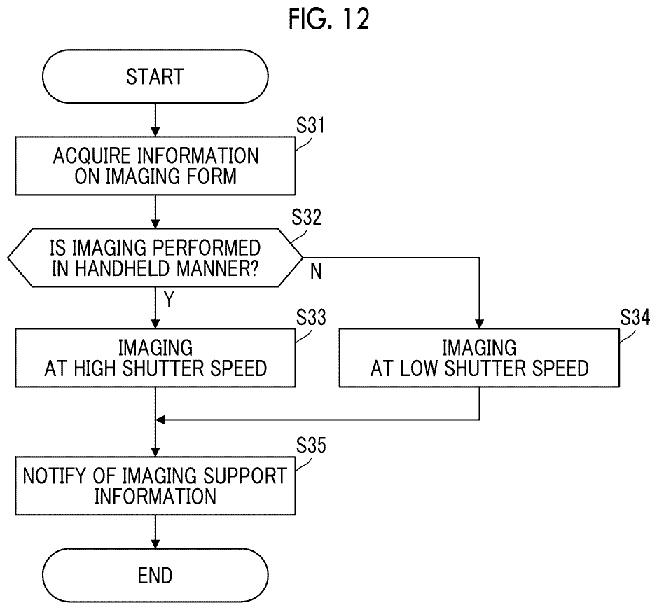

FIG. 12 is a flowchart illustrating a procedure of processing of providing the imaging support information in the three-dimensional model generation device.

First, the information on the imaging form is acquired from the user (step S31). In the present embodiment, the information on the imaging form is acquired by receiving the input of the information on the imaging form from the user. The information on the imaging form is information on whether the imaging is performed in a handheld manner.

The three-dimensional model generation device 100 determines the imaging condition based on the acquired information on the imaging form (information on whether the imaging is performed in a handheld manner). First, it is determined whether the imaging is performed in a handheld manner (step S32). In a case of the imaging in a handheld manner, the three-dimensional model generation device 100 determines to perform the imaging at a high shutter speed as the imaging condition (step S33). On the other hand, in a case of not performing the imaging in a handheld manner, the three-dimensional model generation device 100 determines to perform the imaging at a low shutter speed as the imaging condition (step S34).

The three-dimensional model generation device 100 notifies the user of the information on the determined imaging condition, as the imaging support information (step S35). In the present embodiment, the information on the determined imaging condition (imaging support information) is displayed on the display unit 105 to notify the user. The imaging support information is provided to the user as optimal imaging setting information (recommended imaging setting information) based on the imaging form.

### (2) Generation of Three-Dimensional Model

The user sets the exposure in response to the presentation of the imaging support information, and images the object to obtain the multi-view image. Therefore, for example, in a case of the imaging in a handheld manner, the object is imaged by setting a higher shutter speed. Therefore, the occurrence of the image blur can be suppressed, and an image suitable for generating the three-dimensional model can be captured. On the other hand, in a case of not performing the imaging in a handheld manner, the object is imaged by setting a low shutter speed.

The captured multi-view image is input to the three-dimensional model generation device 100. The three-dimensional model generation device 100 generates the three-dimensional model by processing the input multi-view image.

In this way, according to the present embodiment, even a user who is not knowledgeable about the imaging can capture a high-quality image suitable for generating the three-dimensional model. As a result, the high-quality three-dimensional model can be easily generated.

### Modification Example

### Imaging Condition

In the above embodiment, the configuration is adopted in which the setting of the shutter speed is determined as the imaging condition, but the item determined as the imaging condition is not limited to this. For example, the shutter speed and the sensitivity (International Organization for Standardization (ISO) sensitivity) can be determined in accordance with the imaging form. In this case, for example, in a case of the imaging in a handheld manner, the sensitivity is set to be high and the shutter speed is set to be high, and in a case of not performing the imaging in a handheld manner, the sensitivity is set to be low and the shutter speed is set to be low. In addition, for example, the shutter speed, the F number (F-value), and the sensitivity can be determined in accordance with the imaging form. In this case, for example, in a case of the imaging in a handheld manner, the F number is fixed, and the sensitivity is set to be high and the shutter speed is set to be high. In addition, in a case of not performing the imaging in a handheld manner, the F number is fixed, and the sensitivity is set to be low and the shutter speed is set to be low.

### Presentation of Imaging Support Information

In the above embodiment, the configuration is adopted in which the imaging support information (information on the imaging condition) is displayed on the display unit 105 of the three-dimensional model generation device 100 to notify the user, but the method of notifying the user of the imaging support information is not limited to this. For example, a configuration may be adopted in which the imaging support information is transmitted to the imaging device 10 and is displayed on the display unit of the imaging device 10.

In addition, in the above embodiment, a case in which the three-dimensional model generation device 100 comprises the imaging support function is described as an example, but the imaging support function may be provided independently and installed in another device. For example, the imaging support function may be installed in the imaging device 10. Alternatively, the imaging support function may be installed in a portable device such as a smartphone or a tablet terminal.

In a case in which the imaging support function is installed in the imaging device 10, the exposure may be automatically set. For example, in a case of the imaging in a handheld manner, the exposure is automatically set to be high shutter speed and high sensitivity. In addition, in a case of not performing the imaging in a handheld manner, the exposure is automatically set to be low shutter speed and low sensitivity.

In addition, a configuration may be adopted in which the imaging device 10 and the three-dimensional model generation device 100 are communicably connected, and the imaging condition determined by the three-dimensional model generation device 100 is automatically reflected in the imaging device 10.

### Generation Method of Three-Dimensional Model

In the above embodiment, a case of generating the three-dimensional model of the object from the multi-view image by the photogrammetry is described as an example, but the same applies to a case of generating the three-dimensional model by using other methods (for example, the visual hull method).

### Fifth Embodiment

As described above, there is a form in which the imaging is performed using the turntable, as the imaging form of the multi-view image. In the imaging using the turntable, since the subject side moves, so-called subject blur (motion blur) occurs unless the imaging is performed by setting an appropriate shutter speed. The image in which the subject blur has occurred adversely affects the generation of the three-dimensional model.

In the present embodiment, a system is presented that can capture a high-quality image suitable for generating the three-dimensional model even for a user who is not knowledgeable about the imaging.

### Three-Dimensional Model Generation System

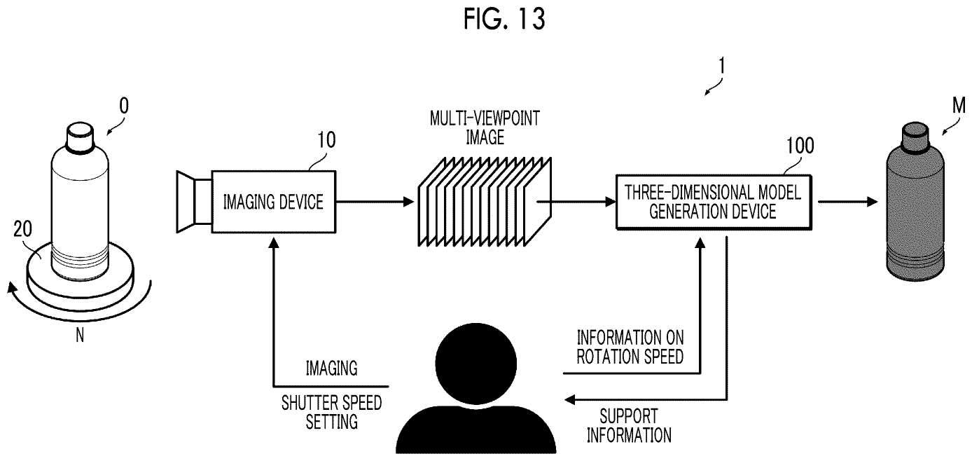

FIG. 13 is a diagram illustrating a schematic configuration of the three-dimensional model generation system.

The three-dimensional model generation system 1 according to the present embodiment is configured as a system that generates the three-dimensional model M of the object O from the multi-view image.

As illustrated in FIG. 13, the three-dimensional model generation system 1 comprises an imaging device 10 and a three-dimensional model generation device 100.

### Imaging Device

The imaging device 10 is a device that images the object O. The imaging device 10 is configured by a general digital camera.

The imaging device 10 is fixed by a tripod and the like, and images the object O that rotates at a fixed position from the fixed position. As an example, in the present embodiment, the object O is placed on a turntable 20 and is rotated. The turntable 20 rotates at a constant rotation speed N [rpm].

A configuration may also be adopted in which the imaging is performed by using a plurality of imaging devices 10. In this case, for example, the object O is simultaneously imaged from different positions or directions by using a plurality of imaging devices 10.

### Three-Dimensional Model Generation Device

A hardware configuration of the three-dimensional model generation device 100 is the same as that of the three-dimensional model generation device 100 according to the first embodiment. That is, the three-dimensional model generation device 100 is configured by a computer, such as a PC, and comprises a processor 101, a main storage unit 102, an auxiliary storage unit 103, an operation unit 104, a display unit 105, an interface unit 106, and the like (see FIG. 2).

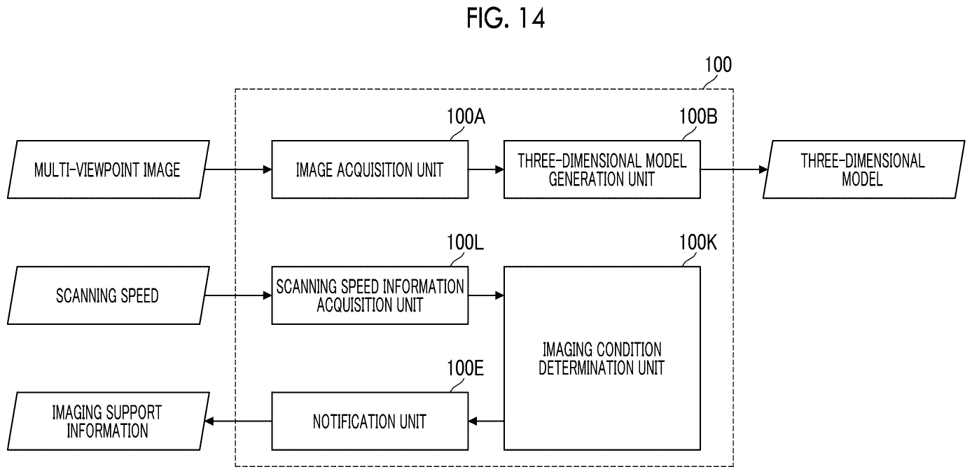

FIG. 14 is a block diagram illustrating the main functions of the three-dimensional model generation device.

The three-dimensional model generation device 100 has a function (three-dimensional model generation function) of generating the three-dimensional model of the object from the multi-view image and a function (imaging support function) of supporting the imaging of the multi-view image.

### Three-Dimensional Model Generation Function

The three-dimensional model generation function is the same as the three-dimensional model generation function in the three-dimensional model generation device 100 according to the third embodiment. Therefore, the description will not be repeated.

### Imaging Support Function

In the present embodiment, as the imaging support function, the information on the imaging form is acquired from the user, the imaging condition is determined based on the acquired information, and the imaging condition is presented to the user. As illustrated in FIG. 14, the three-dimensional model generation device 100 has functions of a scanning speed information acquisition unit 100L, an imaging condition determination unit 100K, a notification unit 100E, and the like, as the imaging support function.

The scanning speed information acquisition unit 100L acquires information on the scanning speed (scanning speed information). The scanning speed is a speed at which the object O is scanned. As described above, in the present embodiment, the object O that rotates is imaged from the fixed position to scan the object O. Therefore, the rotation speed of the object O is the scanning speed. The rotation speed of the object O is a speed (rotation speed N) at which the turntable 20 rotates. Therefore, the scanning speed information acquisition unit 100L acquires the information on the rotation speed N of the turntable 20, as the information on the scanning speed. The scanning speed information acquisition unit 100L acquires the information on the scanning speed (rotation speed of the turntable 20) by receiving the input of the information on the scanning speed by the user. The scanning speed information acquisition unit 100L displays a predetermined input screen on the display unit 105, and receives the input of the information on the scanning speed by the user. The input operation is performed via the operation unit 104. In the present embodiment, the information on the scanning speed (information on the imaging condition) acquired by the scanning speed information acquisition unit 100L is an example of the first information.

The imaging condition determination unit 100K determines the imaging condition based on the information on the scanning speed (rotation speed of the turntable 20) acquired from the user. Specifically, the imaging condition determination unit 100K determines the shutter speed. The shutter speed is a shutter speed at which the subject blur can be suppressed.

Here, as the shutter speed is higher, the effect of suppressing the subject blur can be improved. On the other hand, in order to increase the shutter speed, the sensitivity needs to be increased (in a case in which the F number is fixed). As the sensitivity is increased, the noise component increases (an SN ratio is reduced). Therefore, it is preferable to set the shutter speed to a minimum speed at which the subject blur can be suppressed.

In this embodiment, the information on the imaging condition (information on the shutter speed) determined by the imaging condition determination unit 100K is an example of the second information.

The notification unit 100E notifies the user of the information on the imaging condition (information on the shutter speed) determined by the imaging condition determination unit 100K, as the imaging support information. For example, in the present embodiment, the information on the determined imaging condition (imaging support information) is displayed on the display unit 105 to notify the user.

### Generation of Three-Dimensional Model

Hereinafter, a method of generating the three-dimensional model M of the object O from the multi-view image using the three-dimensional model generation system 1 according to the present embodiment will be described.

### (1) Provision of Imaging Support Information

First, the three-dimensional model generation device 100 provides the imaging support information.

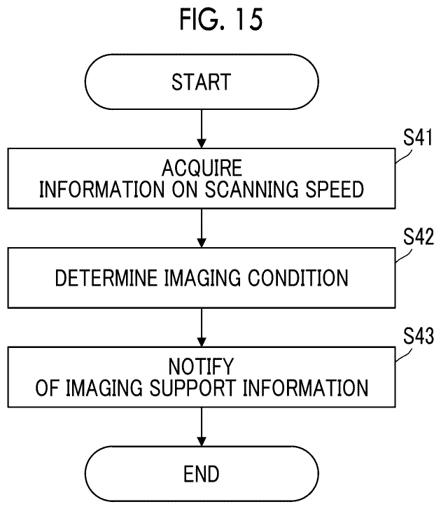

FIG. 15 is a flowchart illustrating a procedure of processing of providing the imaging support information in the three-dimensional model generation device.

First, the information on the scanning speed is acquired from the user (step S41). In the present embodiment, the information on the rotation speed N of the turntable 20 is acquired by receiving the input of the information on the scanning speed by the user.

The three-dimensional model generation device 100 determines the imaging condition based on the acquired information on the scanning speed (step S42). In the present embodiment, the shutter speed at which the subject blur can be suppressed is determined.

The three-dimensional model generation device 100 notifies the user of the information on the determined imaging condition (shutter speed), as the imaging support information (step S43). In this embodiment, the information on the determined imaging condition (shutter speed) is displayed on the display unit 105 to notify the user. The imaging support information is provided to the user as optimal shutter speed setting information (recommended shutter speed setting information) based on the scanning speed.

### (2) Generation of Three-Dimensional Model

The user sets the exposure in response to the presentation of the imaging support information, and images the object. More specifically, the object is imaged by setting the shutter speed to be presented by the three-dimensional model generation device 100 and setting the F number and the sensitivity such that optimal exposure is obtained.

In this way, the imaging is performed using the turntable 20. That is, the object O is placed on the turntable 20 and is rotated at a constant speed to be imaged. The imaging device 10 images the object O that rotates, from the fixed position.

The captured multi-view image is input to the three-dimensional model generation device 100. The three-dimensional model generation device 100 generates the three-dimensional model by processing the input multi-view image.

In this way, according to the present embodiment, even a user who is not knowledgeable about the imaging can capture a high-quality image suitable for generating the three-dimensional model. As a result, the high-quality three-dimensional model can be easily generated.

### Modification Example

### Imaging Condition

In the above embodiment, the configuration is adopted in which the shutter speed is determined as the imaging condition, but the item determined as the imaging condition is not limited to this. For example, an imaging interval may be determined in addition to or instead of the shutter speed. By adjusting the imaging interval, an image overlap rate between adjacent images can be adjusted. By appropriately setting the imaging interval, the omission of imaging (missed imaging) can be suppressed.

### Imaging Form

In the above embodiment, the configuration is adopted in which the object that rotates is imaged from the fixed position, but a configuration may be adopted in which the imaging device side is rotated to perform the imaging. For example, a configuration may be adopted in which the imaging is performed by an imaging device that rotates (revolves) at a constant speed around the stationary object. In such a case, the rotation speed (revolution speed) of the imaging device is the scanning speed. In addition, a configuration may be adopted in which the imaging is performed by an imaging device that rotates (revolves) at a constant speed around the object that rotates (spins) at a constant speed. In this case, a difference between the rotation speed (revolution speed) of the imaging device and the rotation speed (spinning speed) of the object is the scanning speed.

### Presentation of Imaging Support Information

In the above embodiment, the configuration is adopted in which the imaging support information (information on the imaging condition) is displayed on the display unit 105 of the three-dimensional model generation device 100 to notify the user, but the method of notifying the user of the imaging support information is not limited to this. For example, a configuration may be adopted in which the imaging support information is transmitted to the imaging device 10 and is displayed on the display unit of the imaging device 10.

In addition, in the above embodiment, a case in which the three-dimensional model generation device 100 comprises the imaging support function is described as an example, but the imaging support function may be provided independently and installed in another device. For example, the imaging support function may be installed in the imaging device 10. Alternatively, the imaging support function may be installed in a portable device such as a smartphone or a tablet terminal.

In a case in which the imaging support function is installed in the imaging device 10, the exposure may be automatically set. That is, the exposure is automatically set by setting the determined shutter speed.

In addition, a configuration may be adopted in which the imaging device 10 and the three-dimensional model generation device 100 are communicably connected, and the imaging condition determined by the three-dimensional model generation device 100 is automatically reflected in the imaging device 10.

### Generation Method of Three-Dimensional Model

In the above embodiment, a case of generating the three-dimensional model of the object from the multi-view image by the photogrammetry is described as an example, but the same applies to a case of generating the three-dimensional model by using other methods (for example, the visual hull method).

It can be applied to a case of generating the three-dimensional model by other methods. For example, it can be applied to a case of generating the three-dimensional model by using a LiDAR method, a ToF method, a structured light method, and the like. For example, in a case of generating the three-dimensional model by the LiDAR method and the ToF method, the optimal measurement condition is determined based on the information on the scanning speed, and is presented to the user, or automatically set.

### Sixth Embodiment

It is preferable that the quality of the generated three-dimensional model is set in accordance with the importance of the generated three-dimensional model. That is, the three-dimensional model having higher importance is generated with higher quality (reproduction degree or image quality). In general, the number of images or the number of measurement data required for processing is increased as the quality of the three-dimensional model is increased. In addition, the processing man-hours are increased and the processing time is increased as the quality is increased.

It is difficult for a user who is not knowledgeable about the generation of the three-dimensional model to appropriately set the processing in accordance with the importance of the three-dimensional model.

In the present embodiment, a system is presented that can appropriately set the necessary processing in accordance with the importance of the three-dimensional model to be generated even for a user who is not knowledgeable about the generation of the three-dimensional model, and can generate the three-dimensional model having the quality in accordance with the importance.

### Three-Dimensional Model Generation System

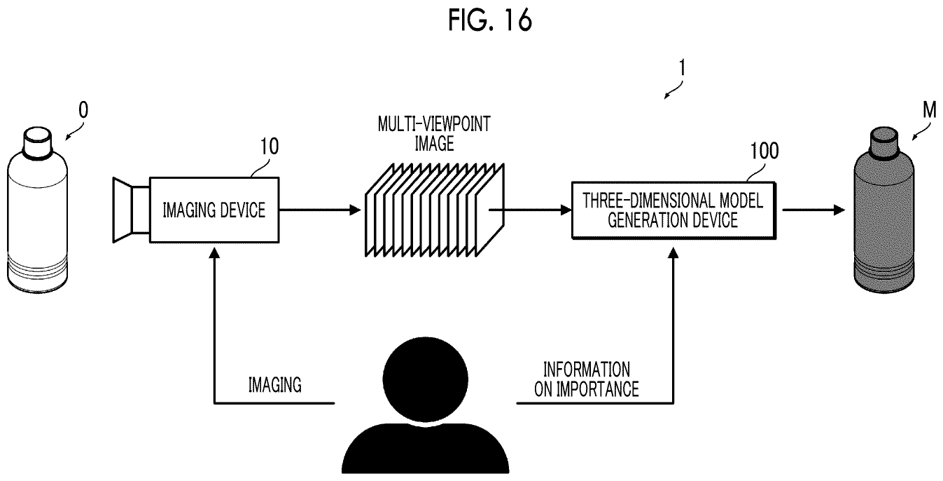

FIG. 16 is a diagram illustrating a schematic configuration of the three-dimensional model generation system.

The three-dimensional model generation system 1 according to the present embodiment is configured as a system that generates the three-dimensional model M of the object O from the multi-view image.

As illustrated in FIG. 16, the three-dimensional model generation system 1 comprises an imaging device 10 and a three-dimensional model generation device 100.

### Imaging Device

The imaging device 10 is a device that images the object O. The imaging device 10 is configured by a general digital camera. The imaging may be performed by one imaging device 10 or a plurality of imaging devices 10.

### Three-Dimensional Model Generation Device

A hardware configuration of the three-dimensional model generation device 100 is the same as that of the three-dimensional model generation device 100 according to the first embodiment. That is, the three-dimensional model generation device 100 is configured by a computer, such as a PC, and comprises a processor 101, a main storage unit 102, an auxiliary storage unit 103, an operation unit 104, a display unit 105, an interface unit 106, and the like (see FIG. 2).

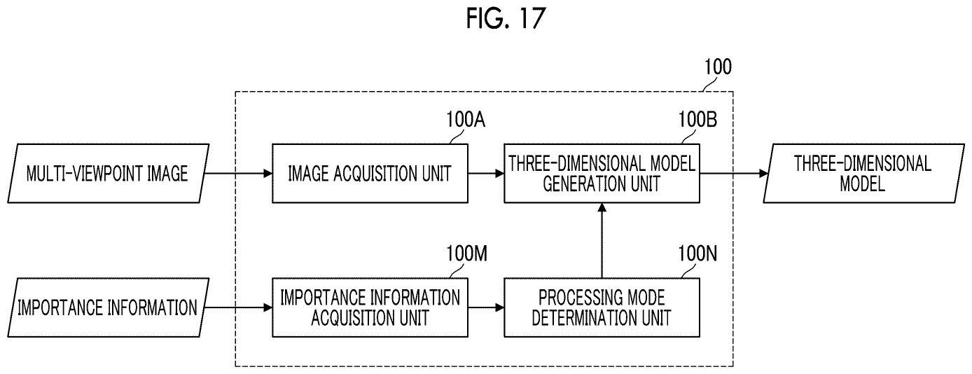

FIG. 17 is a block diagram illustrating the main functions of the three-dimensional model generation device.

As illustrated in FIG. 17, the three-dimensional model generation device 100 has functions of an image acquisition unit 100A, a three-dimensional model generation unit 100B, an importance information acquisition unit 100M, a processing mode determination unit 100N, and the like. The functions of the respective units are achieved in a case in which the processor 101 executes a predetermined program.

The image acquisition unit 100A acquires the multi-view image of the object. The multi-view image is captured by the imaging device 10, stored in the auxiliary storage unit 103, and read out and acquired from the auxiliary storage unit 103. Further, the multi-view image may be directly acquired from the imaging device 10.

The three-dimensional model generation unit 100B generates the three-dimensional model from the multi-view image. As an example, in the present embodiment, the three-dimensional model of the object is generated from the multi-view image by the photogrammetry. The three-dimensional model generation unit 100B generates the three-dimensional model of the object by processing the multi-view image in the processing mode determined by the processing mode determination unit 100N.

Here, the “processing mode” is a mode of processing of generating the three-dimensional model of the object from the multi-view image. By changing the processing mode, the quality of the generated three-dimensional model changes. As an example, in the present embodiment, two processing modes, that is, a “high-quality mode” and a “low-quality mode” are provided. The “high-quality mode” is a mode in which the high-quality three-dimensional model can be generated. The “low-quality mode” is a mode in which a low-quality three-dimensional model is generated as compared to the high-quality mode. The quality of the generated three-dimensional model is adjusted by changing the setting of specific parameters in each mode. For example, in the present embodiment, the quality of the generated three-dimensional model is adjusted by changing the setting of the number of images used for generating the three-dimensional model and the number of repetitions of the recursive estimation processing of the three-dimensional shape. In the high-quality mode, the number of images to be used is set to be larger, and the number of repetitions of the recursive estimation processing of the three-dimensional shape is set to be larger. In the low-quality mode, the number of images to be used and the number of repetitions of the recursive estimation processing of the three-dimensional shape are set to be the minimum necessary. By setting the number of images to be used to be large and setting the number of repetitions of the recursive estimation processing of the three-dimensional shape to be large, it is possible to generate the high-quality three-dimensional model, but the processing man-hours increase and it takes time to generate the three-dimensional model. On the other hand, by setting the number of images to be used and the number of repetitions of the recursive estimation processing of the three-dimensional shape to be the minimum necessary, the time required for generation can be shortened.

The importance information acquisition unit 100M acquires information on the importance (importance information) of the three-dimensional model to be generated. Here, the “importance” is determined subjectively by the user. The required quality is higher as higher importance is set. The importance information acquisition unit 100M acquires the information on the importance by receiving the input of the importance information from the user. As an example, in the present embodiment, the importance is divided into two stages, that is, “high” and “low”, and the information on the importance is acquired. The importance information acquisition unit 100M displays a predetermined selection screen (screen for selecting “high” or “low” for the importance) on the display unit 105, and receives the input (selection) of the information on the importance from the user. The selection operation is performed through the operation unit 104. In the present embodiment, the information on the importance acquired by the importance information acquisition unit 100M is an example of the first information.

The processing mode determination unit 100N determines the processing mode based on the importance information acquired from the user. In the present embodiment, the processing mode is determined by selecting any one of the high-quality mode or the low-quality mode. Specifically, in a case in which the importance is “high”, the high-quality mode is selected, and in a case in which the importance is “low”, the low-quality mode is selected. In the present embodiment, the information on the processing mode of the three-dimensional model determined by the processing mode determination unit 100N is an example of the second information.

This information on the processing mode determined by the processing mode determination unit 100N is added to the three-dimensional model generation unit 100B. The three-dimensional model generation unit 100B generates the three-dimensional model of the object by processing the multi-view image in the processing mode determined by the processing mode determination unit 100N.

### Generation of Three-Dimensional Model

Hereinafter, a method of generating the three-dimensional model M of the physical object O using the three-dimensional model generation system 1 according to the present embodiment will be described.

First, the object O is imaged from the multi-viewpoints using the imaging device 10. The imaging may be performed using one imaging device 10 or may be performed using a plurality of imaging devices 10.

The captured multi-view image is input to the three-dimensional model generation device 100 to generate the three-dimensional model.

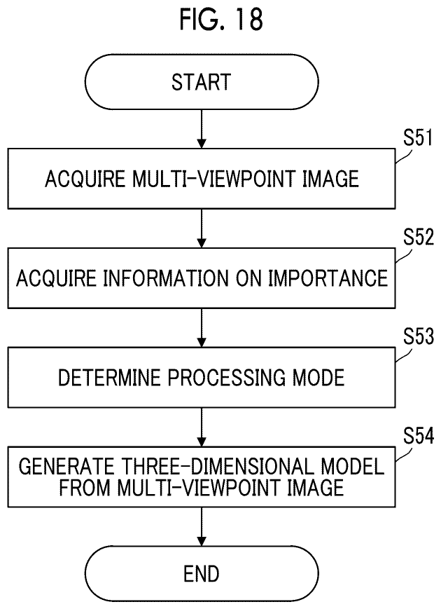

FIG. 18 is a flowchart illustrating a procedure of processing of generating the three-dimensional model from the multi-view image.

First, the multi-view image of the object is acquired (step S51).

Next, the information on the importance of the three-dimensional model to be generated is acquired (step S52). In the present embodiment, the information on the importance is information of “high” or “low”. The three-dimensional model generation device 100 acquires the information on the importance of the three-dimensional model to be generated by receiving the input (selection) of the importance information from the user.

Next, the mode (processing mode) of the processing of generating the three-dimensional model is determined based on the acquired information on the importance (step S53). In the present embodiment, the processing mode is determined by selecting any one of the high-quality mode or the low-quality mode. Specifically, in a case in which the importance is “high”, the high-quality mode is selected, and in a case in which the importance is “low”, the low-quality mode is selected.

Next, the three-dimensional model is generated by processing the multi-view image in the determined processing mode (step S54). For example, in a case in which the high-quality mode is selected, the multi-view image is processed in the high-quality mode to generate the three-dimensional model. On the other hand, in a case in which the low-quality mode is selected, the multi-view image is processed in the low-quality mode to generate the three-dimensional model. In the high-quality mode, the high-quality three-dimensional model is generated. On the other hand, in the low-quality mode, the low-quality three-dimensional model is generated as compared to the high-quality mode.

As described above, with the three-dimensional model generation system 1 according to the present embodiment, the processing condition (processing mode) is automatically set in accordance with the importance of the three-dimensional model to be generated, and the three-dimensional model is generated. As a result, even a user who is not knowledgeable about three-dimensional scanning can appropriately generate the three-dimensional model having the quality in accordance with the importance. That is, the high-quality three-dimensional model can be generated for the one having high importance, and the one having low importance can be generated without taking time.

### Modification Example

### Importance Information

In the above embodiment, the importance is divided into two stages of “high” and “low”, and the information is acquired, but the importance may be acquired by being divided into more stages.

### Processing Condition in Case of Generating Three-Dimensional Model

In the above embodiment, the configuration is adopted in which the mode (processing mode) of the processing is determined as the processing condition, but the content of the processing condition to be determined is not limited to this. A configuration may be adopted in which specific processing parameters (setting of the number of images used for generating the three-dimensional model, the number of repetitions of the recursive estimation processing of the three-dimensional shape, and the like) are individually determined based on the information on the importance.

### Generation Method of Three-Dimensional Model

In the above embodiment, a case of generating the three-dimensional model of the object from the multi-view image by the photogrammetry is described as an example, but the method of generating the three-dimensional model of the object is not limited to this. Other generation methods may also be adopted. It can be applied to a case of generating the three-dimensional model by using the measurement data of the image, such as the LiDAR method and the ToF method.

### Manual Selection

In the above embodiment, a case of automatically generating the three-dimensional model in the determined processing mode is described as an example, but a configuration in which the processing mode is manually selected in accordance with the determination, and the three-dimensional model is generated in the selected processing mode may be adopted. In this case, the user is notified of the information on the determined processing mode. The user selects the processing mode by referring to the notified information, and generates the three-dimensional model.

### Presentation of Other Information

In the above embodiment, the configuration is adopted in which the processing condition in a case of generating the three-dimensional model is determined based on the information on the importance of the three-dimensional model to be generated, but the configuration may be adopted in which the imaging condition, the measurement condition, or the like is determined based on the importance information and is presented to the user. For example, the number of images to be captured or the number of data to be measured may be determined based on the information on the importance of the three-dimensional model to be generated, and may be presented to the user. In addition, the overlap rate in adjacent images or the overlap rate in the measurement range may be determined based on the information on the importance of the three-dimensional model to be generated, and may be presented to the user.

### Other Embodiments

The hardware that implements the information processing system according to the embodiment of the present invention may be configured using various processors. Examples of the various processors include: a general-purpose processor such as a central processing unit (CPU) that executes programs to function as various processing units; a programmable logic device (PLD), such as a field-programmable gate array (FPGA), whose circuit configuration can be changed after manufacture; and a dedicated electric circuit having a circuit configuration designed specifically to execute particular processing, such as an application-specific integrated circuit (ASIC). One processing unit constituting the information processing system may be configured using any one of the above-described processors, or using two or more processors of the same or different types. For example, a processing unit may be constituted by a plurality of FPGAs, or by a combination of a CPU and an FPGA. It is also possible to implement a plurality of processing units using a single processor. As a first example of configuring a plurality of processing units with a single processor, as typified by computers such as clients and servers, a single processor is constituted by a combination of one or more CPUs and software, and this processor functions as a plurality of processing units. Second, as typified by a system-on-chip (SoC), there is a mode that uses a processor which implements, on a single IC (Integrated Circuit) chip, the functions of an entire system that includes a plurality of processing units. In this manner, the various processing units are, as hardware structures, configured using one or more of the above processors. Furthermore, the hardware structures of these processors are, more specifically, electrical circuits (circuitry) formed by combinations of circuit elements such as semiconductor devices.

### Explanation of References

1: three-dimensional model generation system
10: imaging device
20: turntable
100: three-dimensional model generation device
100A: image acquisition unit
100B: three-dimensional model generation unit
100B1: first processing unit
100B2: second processing unit
100B3: composite processing unit
100C: object information acquisition unit
100D: generation method determination unit
100E: notification unit
100F: transparent region extraction unit
100G: illumination information acquisition unit
100H: imaging method determination unit
100J: imaging form information acquisition unit
100K: imaging condition determination unit
100L: scanning speed information acquisition unit
100M: importance information acquisition unit
100N: processing mode determination unit
101: processor
102: main storage unit
103: auxiliary storage unit
104: operation unit
105: display unit
106: interface unit
M: three-dimensional model
O: object
S1 to S4: procedure of processing of determining generation method of three-dimensional model
S11 to S14: procedure of generation processing of three-dimensional model
S21 to S25: procedure of processing of providing imaging support information
S31 to S35: procedure of processing of providing imaging support information
S41 to S43: procedure of processing of providing imaging support information
S51 to S54: procedure of processing of generating three-dimensional model

What is claimed is:

1. An information processing system comprising:
at least one processor configured to:
acquire first information including at least one of information on an object, information on an environment in which the object is imaged or measured, information on a condition under which the object is imaged or measured, or information on importance of imaging or measurement; and
generate second information on generation of three-dimensional data of the object based on the first information.

2. The information processing system according to claim 1,
wherein the processor is configured to acquire the first information by receiving input of the first information from a user.

3. The information processing system according to claim 1,
wherein the information on the object includes information on a transparent region,
the information on the environment in which the object is imaged or measured includes information on an illumination status, and
the information on the condition under which the object is imaged or measured includes at least one of information on whether the imaging or the measurement is performed in a handheld manner or information on a scanning speed.

4. The information processing system according to claim 1,
wherein the second information is information on a method used for the generation of the three-dimensional data, and
the processor is configured to determine the method used for the generation of the three-dimensional data based on the first information.

5. The information processing system according to claim 4,
wherein the first information includes at least information on a transparent region of the object, and
the processor is configured to determine the method used for the generation of the three-dimensional data based on the information on the transparent region.

6. The information processing system according to claim 5,
wherein the first information includes at least one of information on whether the transparent region is present or information on a proportion of the transparent region in the object, as the information on the transparent region, and
the processor is configured to determine the method used for the generation of the three-dimensional data based on at least one of the information on whether the transparent region is present or the information on the proportion of the transparent region in the object.

7. The information processing system according to claim 6,
wherein the processor is configured to determine whether to use photogrammetry or a visual hull method as the method used for the generation of the three-dimensional data.

8. The information processing system according to claim 5,
wherein the processor is configured to determine the method used for the generation of the three-dimensional data for each region of the object based on the information on the transparent region.

9. The information processing system according to claim 1,
wherein the second information is information on an imaging method of an image used for the generation of the three-dimensional data,
the first information includes at least information on an illumination status, and
the processor is configured to determine the imaging method of the image used for the generation of the three-dimensional data based on the information on the illumination status.

10. The information processing system according to claim 9,
wherein the processor is configured to determine whether to adopt polarization imaging as the imaging method.

11. The information processing system according to claim 9,
wherein the information on the illumination status includes at least one of information on whether specular reflection has occurred or information on a proportion of a region in which the specular reflection has occurred in the object.

12. The information processing system according to claim 9,
wherein the information on the illumination status includes information on whether an illumination causes specular reflection on the object.

13. The information processing system according to claim 9,
wherein the information on the illumination status includes information on whether an illumination is adjustable.

14. The information processing system according to claim 1,
wherein the first information includes at least information on whether the imaging is performed in a handheld manner, and
the processor is configured to determine an imaging condition of the object based on the information on whether the imaging is performed in a handheld manner, and generate the second information.

15. The information processing system according to claim 14,
wherein the processor is configured to determine, as the imaging condition, a setting of a shutter speed in a case of imaging the object.

16. The information processing system according to claim 1,
wherein the second information is information on an imaging condition of the object,
the first information includes at least information on a scanning speed, and
the processor is configured to determine the imaging condition based on the information on the scanning speed.

17. The information processing system according to claim 16,
wherein the processor is configured to determine, as the imaging condition, a setting of a shutter speed in a case of imaging the object.

18. The information processing system according to claim 1,
wherein the second information is information on a processing condition in a case of generating the three-dimensional data,
the first information includes at least the information on the importance of the imaging or the measurement, and
the processor is configured to determine the processing condition based on the information on the importance of the imaging or the measurement.

19. An information processing method comprising:
a step of acquiring first information including at least one of information on an object, information on an environment in which the object is imaged or measured, information on a condition under which the object is imaged or measured, or information on importance of imaging or measurement; and
a step of generating second information on generation of three-dimensional data of the object based on the first information.

20. A non-transitory, computer-readable tangible recording medium on which a program is recorded, the program causing, when read by a computer, the computer to execute:
a function of acquiring first information including at least one of information on an object, information on an environment in which the object is imaged or measured, information on a condition under which the object is imaged or measured, or information on importance of imaging or measurement; and
a function of generating second information on generation of three-dimensional data of the object based on the first information.
